(19) United States
(12) Patent Application Publication
(10) Pub. No.: US 2009/0009415 A1
(43) Pub. Date: Jan. 8, 2009

(54) RFID antenna and methods

(76) Inventors: Mika Tanska, Oulu (FI); Kimmo Koskiniemi, Oulu (FI)

Correspondence Address: GAZDZINSKI & ASSOCIATES;Peter J. Gutierrez, III, Suite 375, 11440 West Bernardo Court, San Diego, CA, 92127, US

(21) Appl. No.: 12/217,789

(22) Filed: Jul. 8, 2008

(30) Foreign Application Priority Data
Jan. 9, 2006 (FI) 20065008
Dec. 18, 2006 (FI) PCT/FI2006/050563

(51) Int. Cl. H01Q 11/12

(52) U.S. Cl. 343/742

(57) ABSTRACT

An antenna (200) of an RFID reader based on the magnetic field, especially intended for mobile stations. The main coil (220) of the antenna is inductively coupled to the feeding source, whereby the main coil becomes galvanically isolated from the source. For this purpose, the antenna structure includes an auxiliary coil (230) and a feed element (240) in addition to the main coil. The auxiliary coil is galvanically connected to the main coil, and there is a relatively strong inductive coupling (M) between the feed element and the auxiliary coil. The feed element is coupled directly to the AC source in the reader, in which case an alternating voltage is induced in the auxiliary coil, and an alternating current is generated in it and the main coil. The connection to the RFID tag in the object is provided with the magnetic field corresponding to that current. The reliability of the antenna improves in comparison to the known antennas, because the mechanical junctions that are susceptible to the deterioration of the contact are omitted.

### PRIORITY AND RELATED APPLICATIONS

This application claims priority to International PCT Application No. PCT/FI2006/050563 entitled “RFID antenna” having an international filing date of Dec. 18, 2006, which claims priority to Finland Patent Application No. 20065008 of the same title filed Jan. 9, 2006, each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

The invention relates to an RFID antenna intended especially for mobile stations.

### BACKGROUND OF THE INVENTION

RFID (Radio Frequency Identification) means a system comprising a memory unit to be placed in an object and containing data, and a reader (device), to which the data can be transferred wirelessly from a close distance. The data to be trans-ferred can be e.g. identification information of the object, location information or information related to a product, such as its price, best before date etc. Said memory unit does not have its own energy source, but the energy required for reading the memory and transmitting the read data is obtained from the magnetic field generated by the reader. Such a memory unit is called a “tag” here because of its small size and specialized use.

In most cases, the reader is an independent device made only for the RFID purpose. It can also be an extension of some other device, such as a mobile station. In that case, the processors and the display of the mobile station are utilized for analyzing and displaying the data read from the tag. Regardless of the way the reader has been implemented, it must have its own wiring for generating the field by which the connection to the tag is established. Some of the RFID systems operate at the microwave frequencies, and in that case the wiring of the reader functions as an antenna. However, most RFID systems, such as those pertaining to the invention described here, operate at the significantly lower frequency of 13.56 MHz. Then said wiring of the reader functions as a mere coil, in which case it develops practically only a magnetic field at the operating frequency. The tag has its own coil, through which a part of the energy of the magnetic field is transferred to the electronic circuits of the tag. Although the wiring of the reader does not radiate electromagnetic energy, it is also called an “antenna” in this description and the claims for the sake of consistency.

In a simple case, the RFID antenna is a planar coil on the same circuit board on which also the other circuits of the reader are. If a mobile phone, for example, is equipped with an RFID reader, there is no room for the antenna coil on the circuit board of the device, and there are also electrical reasons for not placing it on the board. The antenna coil must then be placed somewhere else, e.g. on the inner surface of the cover of the device or on top of the battery. In this case a contact arrangement is needed in the antenna as well for connecting it to another part of the reader. FIG. 1 shows an example of such known RFID antenna. The antenna 100 comprises a coil 120 for generating a magnetic field, contacts 151, 152 of the coil and contact springs 161, 162. The coil has four roughly rectangular conductor turns on the surface of a small antenna circuit board 110. The ends of the coil conductor are relatively close to each other and they join galvanically the contacts 151, 152 on the board 110. These are conductor pads coated with some contact material, such as gold. In this example, the contact springs are so-called pogo pins, i.e. two-part telescope pipes with a contact surface on each end and a helical spring inside. One end of the pogo pin presses by spring force the contact on the antenna circuit board, and the other end e.g. a contact on the main circuit board of the device. In the complete device, the pins are supported by dielectric material, which is not seen in FIG. 1. The contact springs can also be relatively rigid strip conductors, in which the spring force is created by the tension of the bent strip. The antenna circuit board 110 is fastened to a surface of the device by gluing, for example.

As an alternative, the coil conductor and its contacts can be directly processed onto some surface by the IMD technique (In Mould Decoration), for example.

When the coil 120 is fed with alternating current, the magnetic field caused by this energizes a RFID tag that is close enough. The electronic circuits of the tag cause variation in the magnetic field, and this variation includes the data in the tag. The variation of the field is sensed as a variation of the current strength in the reader. In this way the data of the tag is readable.

In the cases described above, the RFID antenna is generally located in a detachable part of the device, such as the rear cover of a mobile phone. The cover must be opened when changing the battery or the SIM card, for example. This entails the drawback that the contact will probably deteriorate in the long run, when the part of the cover is now and then detached and replaced. Even when in place, the cover may move slightly, which can be enough to deteriorate the contact. In addition, in applications in which the antenna contacts remain visible in the end product, the need to shape the contacts so as to be visually satisfying is a drawback.

### SUMMARY OF THE INVENTION

In a first aspect of the invention, a main coil of an RFID reader is disclosed. In one embodiment, the main coil is inductively coupled to the feeding source and then being galvanically isolated from the source. In one variant, the antenna structure includes an auxiliary coil and a feed element in addition to the main coil. The auxiliary coil is galvanically connected to the main coil, and there is a relatively strong inductive coupling between the feed element and the auxiliary coil. The feed element is coupled directly to the alternating current source in the reader, in which case an alternating voltage is induced in the auxiliary coil, and an alternating current is generated in it and in the main coil. The connection to the RFID tag in the object is provided with the magnetic field corresponding to that current.

In the exemplary embodiment, the invention has the advantage that the reliability of an RFID antenna improves in comparison to known prior art antennas, because the mechanical junctions susceptible to deterioration are omitted. Such junctions are not needed at all or they are between parts that never need to be moved. In addition, the exemplary embodiment has further advantages in that the antenna structure has no such contacts that would have to be shaped especially for appearance.

In another aspect of the invention, an antenna for use with an RFID system is disclosed. In one embodiment, the antenna comprises: a primary coil coupled with an auxiliary coil, the primary coil and the auxiliary coil residing within the same plane; and a feed element coupled to an alternating current source; wherein inductive coupling between the auxiliary coil and the feed element isolate the primary coil galvanically from the alternating current source.

In one variant, the RFID system comprises a device comprising a substrate and an outer cover.

In another variant, the primary coil and the auxiliary coil reside on an inner surface of the outer cover of the device. The feed element is located e.g., on the substrate of the device below the auxiliary coil.

In yet another variant, the feed element is located on a surface of an inner casing of the device below the auxiliary coil, and connected to the substrate of the device by one or more contacts.

In a further variant, a ferrite plate is located below the primary coil to shape at least a portion of the magnetic field of the antenna.

In still another variant, the primary coil and the auxiliary coil comprise conductor patterns on an inner surface of the outer cover of the device.

In yet another variant, the respective planes of the auxiliary coil and the feed element are both substantially perpendicular to the plane of the primary coil.

In another variant, the auxiliary coil comprises a substantially rectangular coil comprising a predetermined length and width.

In yet a further variant, the feed element comprises a substantially rectangular coil comprising substantially similar predetermined length and width as the auxiliary coil. The primary coil further comprises a substantially rectangular coil comprising a predetermined length and width, at least one of the length and width of the primary coil being larger than the respective predetermined length and width of the auxiliary coil.

In a further aspect of the invention, a method of operating a radio frequency device is disclosed. In one embodiment, the device comprises a first substrate with a primary coil and a secondary coil disposed thereon, and a second substrate with a feed element and at least terminals from an alternating current source disposed thereon, the second substrate disposed substantially parallel and proximate to the first substrate, and the method comprises: providing current via the terminals; inductively coupling the auxiliary coil and the feed element; and based at least in part on the inductive coupling, isolating the primary coil from the alternating current source.

In one variant, the first substrate is disposed on an outer cover of the radio frequency device, and the second substrate is disposed on an internal casing of the radio frequency device.

In another variant, the act of providing current via the terminals comprises providing alternating current from the source for at least a period of time upon receipt of a signal from an entity external to the device.

In yet another variant the act of isolating the primary coil from the alternating current source comprises isolating the primary coil galvanically.

In another aspect of the invention, an antenna of a radio frequency reader adapted for use inside of a device is disclosed. In one embodiment, the antenna comprises: a main coil adapted to form a magnetic field; and a coupling apparatus to connect the main coil to an alternating current source of the reader, the coupling apparatus comprising: an auxiliary coil; and a feed element. The auxiliary coil is galvanically coupled to the main coil and the feed element is arranged to be directly coupled to the source, and an inductive coupling is only between the auxiliary coil and the feed element to isolate the main coil galvanically from the source, the main coil and the auxiliary coil comprising conductor patterns on a surface of a single antenna substrate. In one variant, the antenna circuit board is fastened to an inner surface of an outer cover of the device. In another variant, the feed element is located on a main circuit board of the device below the auxiliary coil. In a further variant, the feed element is located on a surface of an inner casing of the device below the auxiliary coil, and connected to a main circuit board of the device by one or more contacts. In still another variant, a ferrite plate is located below the main coil to shape the magnetic field of the antenna. In another variant, the main coil and the auxiliary coil comprise conductor patterns on an inner surface of an outer cover of the device. In a further variant, the planes of the auxiliary coil and the feed element are substantially perpendicular to the plane of the main coil. In another aspect of the invention, an antenna of an RFID reader is disclosed. In one embodiment, the antenna comprises: a main coil capable of forming a magnetic field and coupling means to connect the main coil to an alternating current source of the reader, the coupling means comprising an auxiliary coil and a feed element, the auxiliary coil being galvanically coupled to the main coil, and the feed element being arranged to be directly coupled to the source. An inductive coupling is formed only between the auxiliary coil and the feed element, so as to isolate the main coil galvanically from the source. The main coil and the auxiliary coil comprise conductor patterns on a surface of the same substrate.

### BRIEF DESCRIPTION OF THE DRAWINGS

In the following, the invention will be described in detail. Reference will be made to the accompanying drawings, in which

FIG. 1 shows an example of a known RFID antenna,

FIG. 2 presents the principle of an RFID antenna according to the invention as a principled drawing,

FIG. 3 shows the parts of the antenna according to FIG. 2 as seen from the side of the wiring,

FIG. 4 shows an example of the antenna according to FIG. 3 from the side,

FIG. 5 shows another example of an RFID antenna according to the invention from the side,

FIG. 6 shows an example of the location of the antenna according to the invention in a portable device,

FIG. 7 shows a third example of an RFID antenna according to the invention from the side, and

FIG. 8 shows a fourth example of an RFID antenna according to the invention from the side.

### DETAILED DESCRIPTION OF THE INVENTION

Reference is now made to the drawings wherein like numerals refer to like parts throughout.

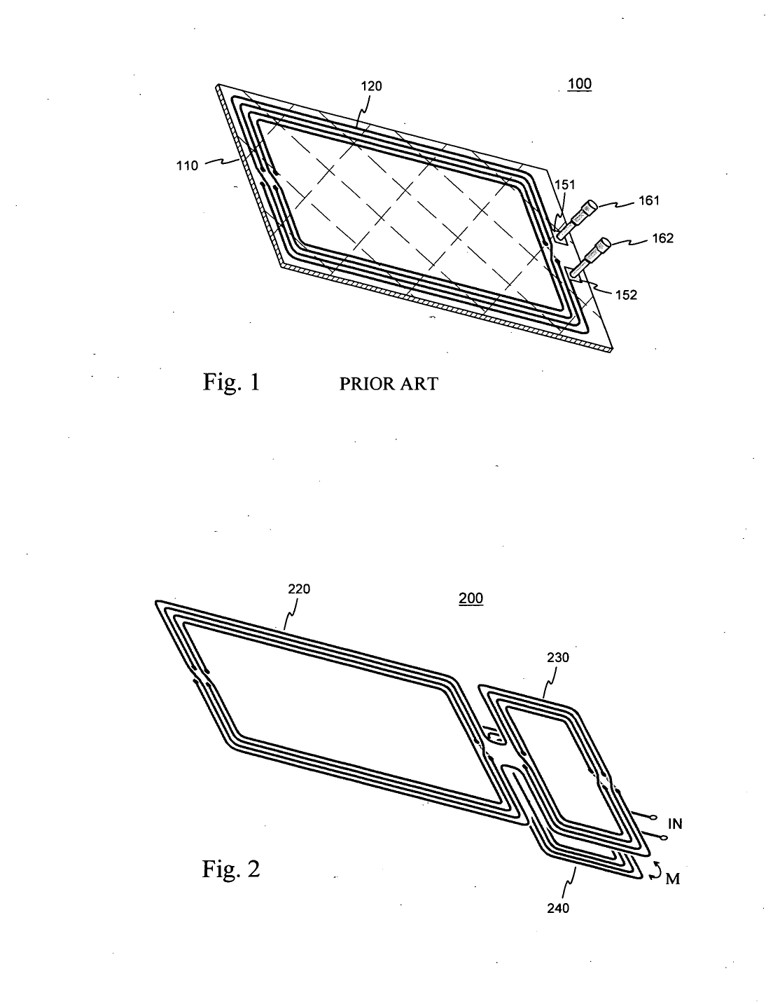

FIG. 1 was explained already in connection with the description of the prior art.

In FIG. 2 there is an example of an RFID antenna according to the invention as a simplified principled drawing. For generating the magnetic field required by the connection, the antenna 200 has a planar coil 220, which is here called the main coil. In this example, the main coil has a rectangular outline, and the ends of its conductor, i.e. the terminals of the main coil, are relatively close to each other at one end of the rectangle. In addition, the antenna includes an auxiliary coil 230 and a feed element 240. The auxiliary coil is located in the same plane as the main coil near its above mentioned end. The terminals of the auxiliary coil are arranged at the terminals of the main coil and are galvanically coupled to them. The feed element 240 is also a planar coil. As viewed in the direction of the normal of the plane represented by the main coil and the auxiliary coil, the feed element is located at the auxiliary coil, below it in FIG. 2. The terminals of the feed element form a port, which is the input IN of the whole antenna. This is connected to the source feeding the antenna in the RFID reader. The distance between the feed element and the auxiliary coil is so small that the mutual inductance M and hence the coupling coefficient between them is considerably high. This means that the magnetic flux caused by the alternating current flowing in the feed element flows mostly through the surface confined by the auxiliary coil 230, in which case the electric field caused by the changing magnetic field appears as an alternating voltage induced in the auxiliary coil. The alternating voltage again causes an alternating current in the auxiliary coil and in the main coil 220 being its “load”. By means of the magnetic field corresponding to this alternating current, a connection to the RFID tag is constituted and its data content is read. In view of the data transfer, the antenna input IN is an input port towards the reader.

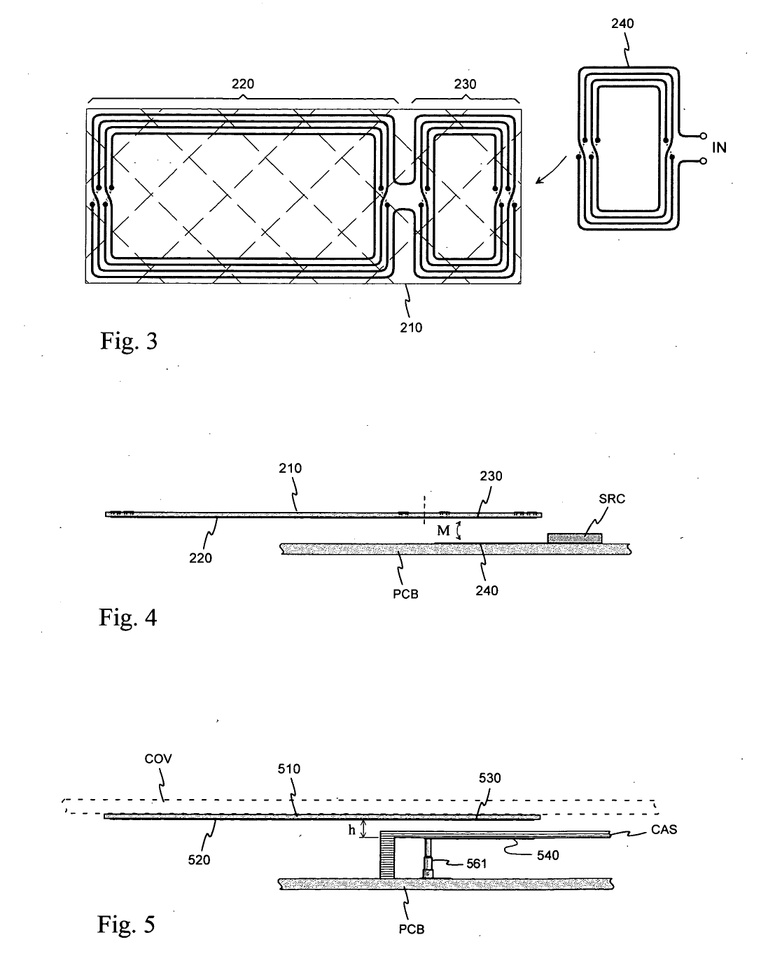

FIG. 3 shows the substantial parts of the antenna according to FIG. 2 as seen from the side of the wiring. The main coil 220 and the auxiliary coil 230 are conductor patterns on the surface of the same antenna circuit board 210. The feed element 240, which is drawn apart from the other parts for clarity, is a coil of the same size and shape as the auxiliary coil. The antenna input IN, to which the ends of the conductor of the feed element are connected, is also seen in the drawing.

FIG. 4 is an example of the antenna according to FIG. 3 as seen from the side. A part of the main circuit board PCB of the device, in which the RFID reader is located, is seen in the drawing. The antenna circuit board 210 is above the main circuit board with the main coil 220 and the auxiliary coil 230 on the surface that is on the side of the circuit board PCB. The feed element 240 is on the upper surface of the circuit board PCB below the auxiliary coil 230. There is a certain mutual inductance M between the feed element and the auxiliary coil. The input of the antenna is directly connected to the alternating current source SRC of the RFID reader located on the circuit board PCB. All the galvanic couplings in the antenna arrangement are fixed, i.e. there are no contacts at all.

In FIG. 5 there is another example of an RFID antenna according to the invention as seen from the side. It shows the circuit board PCB of the device and the antenna circuit board 510, like in FIG. 4. The antenna circuit board is against the inner surface of the outer cover COV of the device. The difference compared to FIG. 4 is that the feed element 540 is now on a surface of the internal casing CAS of the device, which casing is between the outer cover and the circuit board PCB. The feed element is connected to a source on the circuit board PCB by contacts, which are pogo pins in this example. Only one 561 of the two pogo pins is seen in the drawing. The inner casing CAS is unmovably fastened to the circuit board PCB, and thus no significant movement occurs in the junctions of the contacts during the service life of the device.

The distance h between the feed element and the auxiliary coil is for example 2 mm. However, the distance may vary at least in the range 0.5-5 mm. The external dimensions of the main coil are e.g. 3×5 cm² and those of the auxiliary coil and the feed element e.g. 3×1.5 cm². The dimensions of this order of magnitude pertain to an antenna operating in the frequency 13.56 MHz.

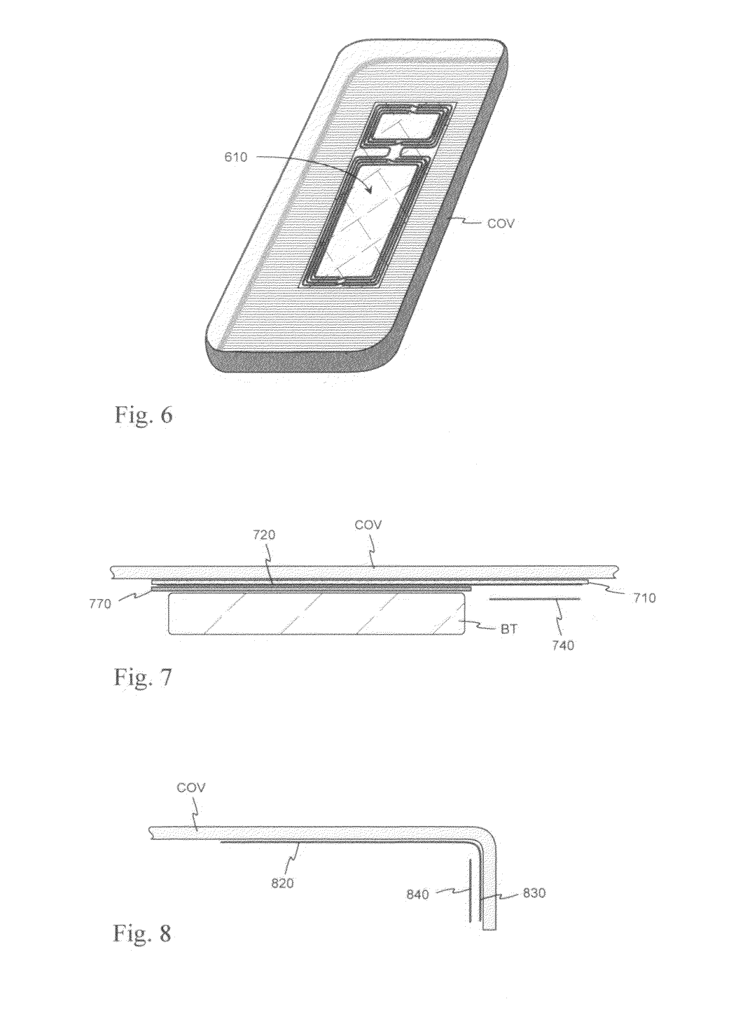

FIG. 6 shows an example of the location of an antenna according to the invention in a mobile device. A half of the outer cover COV of a device, e.g. the rear cover of a mobile phone, is seen in the drawing. An antenna circuit board 610 with its coils, like the one shown in FIG. 3, is fastened to the inner surface of the cover. The circuit board is of a flexible type, for example, in which case it conforms to the possibly arched shape of the cover. The coil conductors can also be processed directly on the inner surface of the cover for example by the IMD technique.

In FIG. 7 there is a third example of an RFID antenna according to the invention as seen from the side. It shows an antenna circuit board 710 against the inner surface of the outer cover COV of a device, like in FIG. 5. The difference between the structures shown in FIGS. 4 and 5 is that the antenna now also includes a ferrite plate 770. This is located between the main coil 720 of the antenna and the battery BT of the device, the battery being then included in the drawing of this example. The ferrite plate isolates the main coil magnetically from the battery and strengthens the field directed outwards. A ferrite plate can be used for shaping the magnetic field, even if there were no battery at the antenna.

FIG. 8 shows a fourth example of an RFID antenna according to the invention as seen from the side. A part of the outer cover COV of the device, the main coil 820 of the antenna, the auxiliary coil 830 and the feed element 840 are seen in the drawing. The main coil is against the long side of the cover, like in the former examples. The difference is that now the auxiliary coil 830 is not in the same plane with the main coil, but in an approximately perpendicular plane, against the end part of the cover. The plane of the feed element 840 is naturally parallel with the plane of the auxiliary coil in this example, too. With the structure of FIG. 8, the magnetic fields of the main coil and the auxiliary coil are not summed in the same way as when the coils are in the same plane. The shape of the overall field is naturally different, having two “beams”.

In this description and the claims, the qualifiers “upper” and “lower” refer to the position of the device when it is lying horizontally in a way that the main coil of its RFID antenna is united to the uppermost part of the outer cover. Naturally, the position in which the device is used can be whatever.

Some structures of the RFID antenna according to the invention have been described above. The shapes and locations of the antenna parts may differ from those presented. In the example of FIGS. 2 and 3, the number of turns in each coil is four. The number of turns can naturally be different, and different coils need not have the same number of turns. In these examples, the coils are also symmetrical so that the halves of the coil conductor from its ends to the midpoint are mirror images of each other. Such symmetry is not necessary, and the coil can be shaped like a spiral, for example. A symmetrical coil may have a tap in the middle to feed it differentially from the ends. The inventive idea can be applied in different ways within the scope defined by the independent claim 1.

1.-7. (canceled)

8. An antenna for use with an RFID system, comprising:
a primary coil coupled with an auxiliary coil, said primary coil and said auxiliary coil residing within the same plane; and
a feed element coupled to an alternating current source;
wherein inductive coupling between said auxiliary coil and said feed element isolate the primary coil galvanically from said alternating current source.

9. The antenna of claim 8, wherein said RFID system comprises a device comprising a substrate and an outer cover.

10. The antenna of claim 9, wherein said primary coil and said auxiliary coil reside on an inner surface of said outer cover of said device.

11. The antenna of claim 10, wherein the feed element is located on said substrate of said device below the auxiliary coil.

12. The antenna of claim 10, wherein the feed element is located on a surface of an inner casing of the device below the auxiliary coil, and connected to said substrate of the device by one or more contacts.

13. The antenna of claim 8, wherein a ferrite plate is located below the primary coil to shape at least a portion of the magnetic field of the antenna.

14. The antenna of claim 9, wherein the primary coil and the auxiliary coil comprise conductor patterns on an inner surface of said outer cover of said device.

15. The antenna of claim 14, wherein the respective planes of the auxiliary coil and the feed element are both substantially perpendicular to the plane of the primary coil.

16. The antenna of claim 8, wherein said auxiliary coil comprises a substantially rectangular coil comprising a predetermined length and width.

17. The antenna of claim 16, wherein said feed element comprises a substantially rectangular coil comprising substantially similar predetermined length and width as said auxiliary coil.

18. The antenna of claim 17, wherein said primary coil further comprises a substantially rectangular coil comprising a predetermined length and width, at least one of said length and width of said primary coil being larger than said respective predetermined length and width of said auxiliary coil.

19. A method of operating a radio frequency device, the device comprising a first substrate with a primary coil and a secondary coil disposed thereon, and a second substrate with a feed element and at least terminals from an alternating current source disposed thereon, the second substrate disposed substantially parallel and proximate to said first substrate, the method comprising:
providing current via said terminals;
inductively coupling said auxiliary coil and said feed element; and
based at least in part on said inductive coupling, isolating the primary coil from said alternating current source.

20. The method of claim 19, wherein said first substrate is disposed on an outer cover of said radio frequency device, and said second substrate is disposed on an internal casing of said radio frequency device.

21. The method of claim 20, wherein said act of providing current via said terminals comprises providing alternating current from said source for at least a period of time upon receipt of a signal from an entity external to said device.

22. The method of claim 20, wherein said act of isolating the primary coil from said alternating current source comprises isolating said primary coil galvanically.

23. An antenna of a radio frequency reader adapted for use inside of a device, the antenna comprising:
a main coil adapted to form a magnetic field; and
a coupling apparatus to connect the main coil to an alternating current source of the reader, said coupling apparatus comprising:
an auxiliary coil; and
a feed element;
wherein the auxiliary coil is galvanically coupled to the main coil and the feed element is arranged to be directly coupled to the source; and
wherein an inductive coupling is only between the auxiliary coil and the feed element to isolate the main coil galvanically from the source, said main coil and said auxiliary coil comprising conductor patterns on a surface of a single antenna substrate.

24. An antenna according to claim 23, wherein the antenna circuit board is fastened to an inner surface of an outer cover of said device.

25. An antenna according to claim 23, wherein the feed element is located on a main circuit board of said device below the auxiliary coil.

26. An antenna according to claim 23, wherein the feed element is located on a surface of an inner casing of the device below the auxiliary coil, and connected to a main circuit board of the device by one or more contacts.

27. An antenna according to claim 23, wherein a ferrite plate is located below the main coil to shape the magnetic field of the antenna.

28. An antenna according to claim 23, wherein the main coil and the auxiliary coil comprise conductor patterns on an inner surface of an outer cover of said device.

29. An antenna according to claim 23, wherein the planes of the auxiliary coil and the feed element are substantially perpendicular to the plane of the main coil.

30. An antenna of an RFID reader, the antenna comprising:
a main coil capable of forming a magnetic field and coupling means to connect the main coil to an alternating current source of the reader, said coupling means comprising an auxiliary coil and a feed element, the auxiliary coil being galvanically coupled to the main coil, and the feed element being arranged to be directly coupled to said source;
wherein an inductive coupling is formed only between the auxiliary coil and the feed element, so as to isolate the main coil galvanically from said source; and
wherein the main coil and the auxiliary coil comprise conductor patterns on a surface of the same substrate.
